(19) United States
(12) Patent Application Publication
(10) Pub. No.: US 2014/0304356 A1
(43) Pub. Date: Oct. 9, 2014

(54) Wireless Aggregator

(71) Applicant: iDevices, LLC, Avon, CT (US)

(72) Inventors: Christopher J. Allen, SR., West Hartford, CT (US); Shawn Montieth, Burlington, CT (US); Eric Ferguson, Coram, NY (US)

(73) Assignee: iDevices, LLC, Avon, CT (US)

(21) Appl. No.: 14/245,829

(22) Filed: Apr. 4, 2014

Related U.S. Application Data
(60) Provisional application No. 61/809,079, filed on Apr. 5, 2013.

(51) Int. Cl. G06F 15/167; H04W 8/24

(52) U.S. Cl. CPC G06F 15/167; H04W 8/24
USPC 709/213

(57) ABSTRACT

Aggregator for communicating with one or more accessory devices having at least one receiver configured to communicate with one or more devices and collect data therefrom, a processor in communication with the at least one receiver, a first memory in communication with the processor and configured to store the collected data, and a second memory in communication with the processor and configured provide read-write capabilities to the aggregator.

### CROSS-REFERENCE TO RELATED APPLICATIONS

This patent application claims benefit under 35 U.S.C. §119 to similarly-titled U.S. Provisional Patent Application No. 61/809,079, filed Apr. 5, 2013, which is hereby incorporated by reference in its entirety as part of the present disclosure.

### FIELD OF THE INVENTION

A wireless aggregator configured to communicate wirelessly or by wire with accessory devices and store information from the accessory devices.

### BACKGROUND INFORMATION

Wireless communication is widely used between devices in users' homes, businesses, and on the go. For example, Bluetooth and other wireless enabled devices can be configured to regularly transmit data to a user for use by the user, e.g., to the user's computing device, such as a desktop computer, mobile computer or tablet (e.g., iPAD, ANDROID, etc.), or mobile phone (e.g., iPhone, ANDROID, etc.). However, the data transmission is made in real time, and if there is no receiver in range, the data is not collected and/or retained.

In addition, where a user has multiple wireless devices, the data must be collected from each device individually. This may require the user to travel to multiple places to where the user, or more specifically, the user's receiving device, is “in range” of the transmitting device in order to receive the data. This is inefficient, inconvenient and time-consuming.

Yet further, in the case of Bluetooth devices, for example, before data can be exchanged, the receiving unit must be “paired” with each device. When the connection between transmitter and receiver is terminated (e.g., out of range), the connection must be re-established for data transmission to take place. The reconnection process can take some time. When it must be done for multiple devices, this adds to the inconvenience.

### SUMMARY OF THE INVENTION

It is an object of the invention to address one or more of the above-described and other drawbacks and/or disadvantages of the prior art.

An aggregating device, an aggregator, allows for continuous communication between accessory devices. The accessory devices can be monitoring devices or other types of devices capable of wired or wireless connections to other devices and are configured to collect data and/or monitor a parameter of interest.

A Bluetooth enabled device, or other wireless electronic device, that is used to collect data, which can include devices such as a thermometer, thermostat, a pool control system, lights, and others (accessory devices), typically transmit data continuously. However, the accessory devices require a receiving device to be within range in order for the transmitted data to be collected because the data is transmitted in real-time. Accordingly, if an accessory device is monitoring something, such as a child's temperature, the temperature data is only collected, such as by a cellular phone or other receiving device, when the receiving device is in range of the accessory device. When a receiving device is not in range, the data is not collected. As such, the user of the receiving device may only observe the child's temperature in real time when connected to and receiving data from the accessory device thermometer. However, when the thermometer is being used and a receiving device is not in range, there is no way to monitor the child's temperature remotely. That data is lost.

The aggregator of the invention may serve as a receiver or base station for one or more accessory devices, thereby providing continuous monitoring of or reception of data from accessory devices in range of the aggregator. Accordingly, the aggregator can be located at a single, static location, and can be configured to communicate with one or more accessory devices. The aggregator can be configured to allow for continuous connection with the accessory devices and therefore can continuously monitor the data transmission of the accessory devices at all times. The data and information transmitted from the accessory devices can be collected by the aggregator and stored for later access by a user. The aggregator may include one or more storage devices, such as non-volatile memory, that can store data collected from the accessory devices. Alternatively, the aggregator can be configured to ping, call, or establish communication with accessory devices to pull or request information from the accessory devices and store the collected information on the aggregator. This could be done at a pre-set time or interval, or upon a request from a user.

A user may place the aggregator within their home or other location where monitoring is necessary or desired, and connect or pair a number of accessory devices that are to be monitored on a continuous or semi-continuous basis. Turning again to the example of the child with a thermometer, the aggregator allows a user, such as a parent, to continuously monitor the child's temperature, even when the parent is not present. The data can also be time-shifted away from the real-time data collection. A user can access the aggregator, which stores the received data, instead of the thermometer itself and can see how the child's temperature has varied over time. This can be repeated for a plurality of accessory devices of different functions and/or types simultaneously.

Access to the aggregator can be through a wireless device such as a Wi-Fi or Bluetooth connected device, through the internet, mobile or cellular network connection, or by wired connection. As such, a user only needs to be in proximity to the aggregator, or otherwise connected to the aggregator, e.g., through the internet, to enable monitoring of the accessory devices that are connected to the aggregator. Access to the aggregator may be accomplished through a web-based interface or other program run on a computer or other device, such as a smart-phone, tablet, or a dedicated controller or device. For example, a computerized application, such as a mobile application (an “app”), may be used to interface with and/or communicate with the aggregator.

Advantageously, the aggregator described herein may provide access security, data storage, data encryption, cloud connection, internet connection, wireless network protocol (e.g., Wi-Fi) connectivity, and Bluetooth connectivity. Access security may be achieved through permitting only specific authorized devices (access devices) to access the information stored on the aggregator. For example, a user's smart phone or other device can be established as an authorized device. Then, every time the authorized device comes into the range of the aggregator, the user may use the authorized device to access the information on the aggregator. Alternatively, an authorized device can be used to access the aggregator remotely through a secure internet connection. Alternatively still, a password may be entered using an access device, and may be remembered or stored on the access device, which allows for communication with the aggregator, directly or through the internet. Accordingly, the aggregator may allow for secure access by employing an authorized device stop-gate such that a device attempting to access the aggregator must establish that it is an authorized device prior to access. Methods and means for establishing and configuring devices as authorized devices are well known in the art, and can include, for example, pass-key access, data identification means, unique identifiers, or other known methods and means. Accordingly, the aggregator is not limited to a single authorization method, but may include any known means and methods that are known or will become known.

Data encryption can also be provided by the aggregator. The processor of the aggregator can encrypt the collected data such that even if an unauthorized user accesses the aggregator, the collected data and information can be protected from unauthorized viewing. Further, when a user accesses the aggregator through the internet, the processor can encrypt any data that is sent through the internet to the user and/or a secure connection can be used.

The aggregator can also be used with accessory devices that store information on the accessory device, and then later transmit the information to the aggregator device. For example, the accessory devices may be configured to periodically or at a pre-set time transmit to the aggregator a time-interval of data collected over a period of time. Alternatively, the aggregator can actively call or communicate with an accessory device to extract or pull information from the accessory device. Accordingly, the aggregator may allow for instantaneous collection of stored, historical, or current information collected by an accessory device. The aggregator can be programmed to actively pull information from accessory devices at pre-programmed intervals and/or may be configured to pull information from accessory devices on demand by a user. Advantageously, this provides power savings to accessory devices that transmit information to the aggregator, as transmission of data may only be initiated when needed, and unnecessary transmissions may be avoided. Moreover, because the aggregator can pull information from a plurality of accessory devices, a user is provided with the convenience of information from a plurality of accessory devices located in a single location, i.e., at the aggregator.

The aggregator may also be configured for cloud storage. The aggregator can transfer data to a remote location, such as a server, that can store the information collected by the aggregator and allow for remote access to the stored information by a user. Further, the cloud connection can allow for an aggregation of data from more than one aggregator. As such, the aggregator allows for a user's data to be collected and stored in a single location on the aggregator and/or at a remote location, without the need to individually access each accessory device to be monitored.

Furthermore, the aggregator can be used and configured to control various accessory devices connected thereto. For example, the aggregator can act a central control hub for a plurality of accessory devices connected to the aggregator. Advantageously, this allows for a user to connect to a single device, the aggregator, rather than connecting to each accessory device individually. A user can connect a number of accessory devices to the aggregator, for example, lights, and then merely connect to the aggregator to turn on or turn off all of the lights, or some subset of the lights connected to the aggregator, rather than needing to connect to each and every light individually to control them. This is particularly advantageous in a “connected” home, set up with various home automation devices, such as plugs and/or outlets, wall switches, power strips, light bulbs, thermostats, locks, garage doors, blinds, space heaters, home heating and cooling, appliances, motion sensors, and other devices that can be connected to and controlled through a wireless communication.

Moreover, in some embodiments, multiple aggregators can be employed to provide communication and control over a larger area and/or to connect with more devices, such as in smart homes, retail, commercial, and industrial settings. For example, a retail store may employ multiple aggregators to monitor inventory of the store, tracking the location of merchandise, maintaining inventory levels, or other various uses over the entire area of the store, and with many pieces of inventory. Multiple aggregators can thus be used to connect and interconnect to devices over a larger physical area than possible with a single aggregator.

Moreover, advantageously, the aggregator described herein provides for power savings for accessory devices through historical data storage. For example, data storage of the aggregator may store monitoring information from an accessory device for a prolonged period, allowing the accessory device to not have to store any historical data thereon. Further, the accessory devices may be configured optimally for monitoring, rather than monitoring and storage. As an example, an accessory device such as a temperature monitor may regularly monitor the temperature of a child, and wirelessly transfer the measurement to the aggregator. There is no requirement for “onboard” storage with the accessory device, and therefore, the accessory device may not need to power ancillary components related to data storage. As another example, the accessory device may only record a short period of time, whereas the aggregator described herein may provide long duration recording, thereby removing the need for extended storage within the accessory device.

### BRIEF DESCRIPTION OF THE DRAWINGS

FIG. 1 is a schematic block diagram of an embodiment of an aggregator; and

FIG. 2 is a schematic of a system including the aggregator as shown in FIG. 1.

### DETAILED DESCRIPTION OF EMBODIMENTS OF THE INVENTION

An aggregator device is configured to communicate, by wire or wirelessly, with one or more accessory electronic devices, to collect information and/or data therefrom, and/or to send commands and control the one or more accessory devices. It may also allow for wireless access by a user using an access device.

An aggregator, which may be programmable, facilitates connection and data transfer among multiple devices such as smart phones, tablet computers, desktop and mobile computers, servers, routers, Bluetooth enabled devices, and other wireless or wired devices (hereinafter “accessory devices”). Accessory devices include any device that transmits data, including, but not limited to, wireless network protocol (e.g., Wi-Fi), radio, BLUETOOTH, over a wired connection or via any format currently known or may hereafter be developed. Some embodiments include multiple standard formats in order to communicate with a variety of types of devices. Accessory devices, as discussed herein, may be used for applications in areas such as automotive, consumer electronics, health and wellness, mobile telephony, personal computers and peripherals, sports and fitness, smart home, and others. By connecting or pairing the accessory devices to the aggregator, data transfer between one or more accessory devices and the aggregator can be implemented, e.g., in real-time. Data sent from the accessory devices and received by the aggregator can be accessed when needed or desired by a user, by connecting or accessing the aggregator, rather than a user needing to connect to each individual accessory device. In embodiments where the data can be stored in memory on the aggregator (or otherwise connected to or accessible by the aggregator, e.g., the cloud or a remote/external storage device) the user can access the data at a time later than the data transmission, again, eliminating real-time requirements for data collection. In other embodiments, the aggregator can transmit or send the information it collects to an internet storage database, such as a server or cloud-based storage, thus eliminating and/or supplementing the need for on-board storage with the aggregator. Access to the aggregator may be achieved through an access device, such as a computer, cellular phone, dedicated device, or any other device suitable for communication with the aggregator, or on a screen or interface of the aggregator itself.

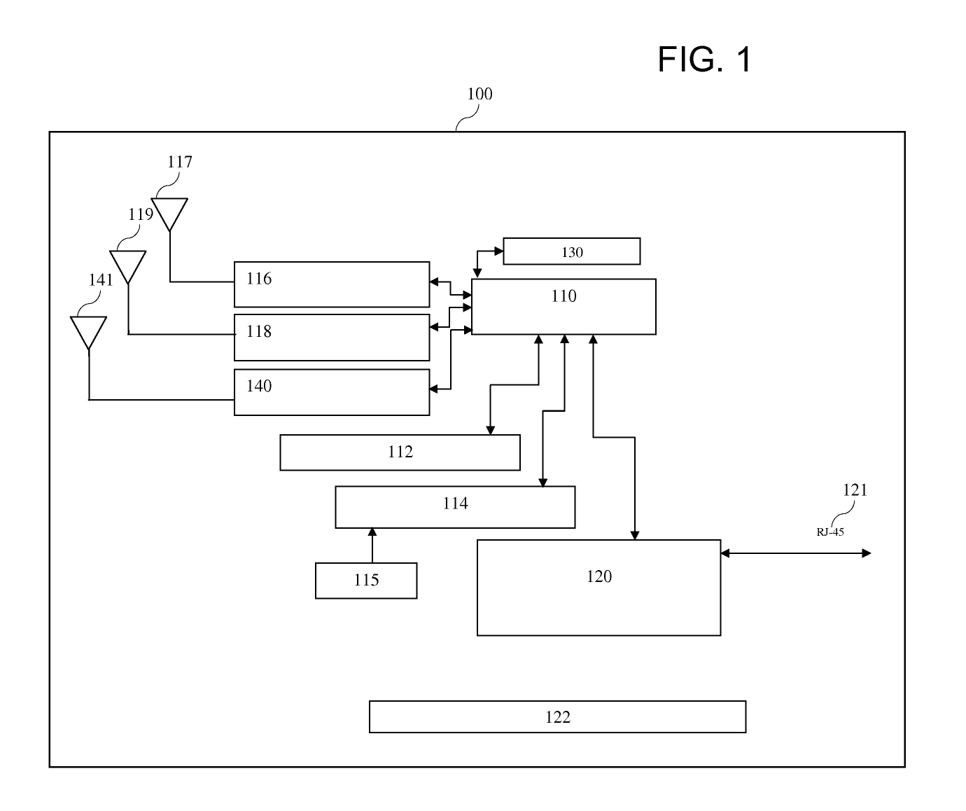

FIG. 1 shows an aggregator 100 with various components, including a processor 110 with storage devices 112 and 114 and antennae, including, for example a Bluetooth antenna 117, a Bluetooth Smart or Bluetooth Low Energy (“BLE”) antenna 119, and a Wi-Fi antenna 141. The aggregator includes hardware, firmware, and software adapted and configured for installation of a computer application adapted and configured to monitor and receive data from accessory devices and/or to control and/or send commands to accessory devices, including firmware updates, command and control instructions, etc. The aggregator 100 is configured to communicate with one or more accessory devices, as described herein. Although shown and described herein with an antenna for multiple wireless connection types, those skilled in the art will appreciate that various other configurations may be used that are known or become known, such as a single connection type, or a multi-function single antenna.

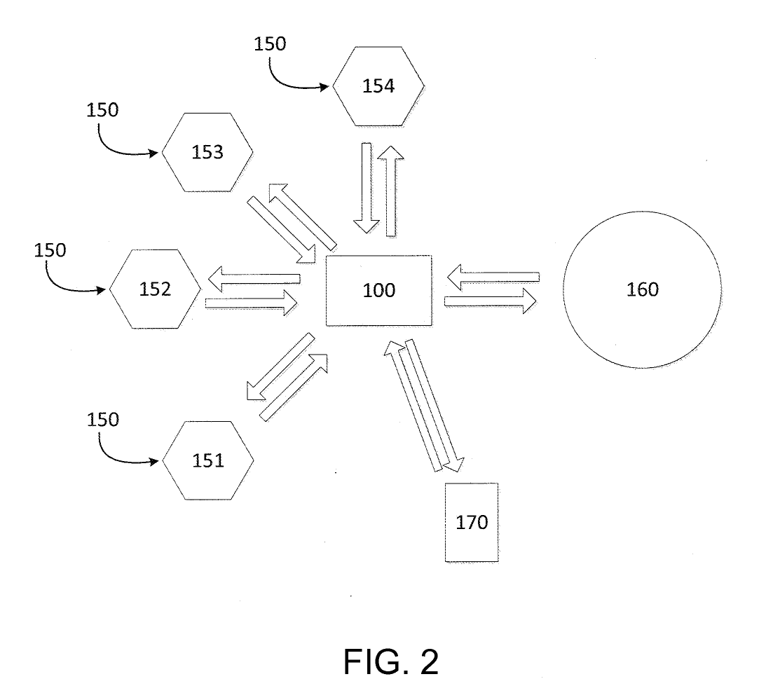

Referring to FIG. 2, the aggregator 100 is shown in an exemplary system set up with multiple accessory devices 150 in communication with the aggregator 100. The aggregator is a “central” device 100, or hub, configured to allow communication to and from a number of accessory devices 150 to collect data, e.g., simultaneously from the accessory devices. The aggregator serves as a single access point, or single collection point, for the accessory devices, and allows for continuous monitoring and/or data collection from the accessory devices. The aggregator 100 and any information stored thereon is accessed by an access device 170, such as a phone or other similar device, or a remote computer that has access to the aggregator 100, as described herein. The aggregator 100 may be configured to connect to and/or be connectable to the internet 160, including cloud based storage and/or programs, which can be configured to store the information collected by the aggregator and/or control the aggregator 100 and/or control the accessory devices 150 connected thereto.

Moreover, as shown in FIG. 2, the communication between the aggregator 100 and the accessory devices 150 can be two-way. This allows for the aggregator to send commands to the accessory devices 150, thereby providing a user with control over multiple accessory devices through a single connection with the access device 170 to the aggregator, rather than requiring a user to connect to each individual accessory device. Alternatively, an access device 170 may be connected to the internet, and can communicate and control the aggregator 100 through the internet 160, for example, using a laptop as an access device, or accessing a webpage that permits access and control over the aggregator and/or the accessory devices connected thereto.

Referring again to FIG. 1, the aggregator, referred to generally as 100, includes a processor 110, such as a programmable microprocessor. The aggregator 100 includes one or more memory storage devices 112 and 114 that are in communication with the processor 110. The storage devices 112 and 114 are non-volatile storage and volatile storage, respectively, that are configured to store collected data and/or programs on the aggregator 100. Additionally, one or more radios 116, 118, and 140 are connected to the processor 110 and are configured to allow communication between the aggregator 110 and one or more accessory devices and/or access device 170 (see FIG. 2) and/or the internet 160. As shown, the radios 116, 118, and 140 are a Bluetooth Low Energy radio 116, a Bluetooth radio 118, and a Wi-Fi radio 140, respectively. The radios 116, 118, and 140 are further connected to antennae 117, 119, and 141, respectively, that are used to receive and/or transmit data and/or information to or from the aggregator 100 and connect the aggregator 100 to the Internet 160. The antenna 117, 119, 140 may be located internally or externally to the aggregator. An external antenna may be connected by any suitable means, e.g., hardwire, data cable (e.g., USB etc.). The aggregator 100, as shown, also includes an Ethernet controller 121 that is in communication with the processor and configured to allow the aggregator 100 to connect to, and communicate over, the Internet 160. Accordingly, the aggregator 100 can be adapted and/or configured to download and/or store information from the internet via Wi-Fi, e.g., a wireless adapter, or Ethernet. A power supply 122 and a battery 115 are also provided to power the aggregator 100 and/or individual elements included in the aggregator 100. The power supply 122 is configured to connect the aggregator 100 to a wall outlet or other external power source. The battery 115 serves as a back-up power support for the aggregator 100, in the event of power loss or other event.

The processor 110 contains one or more executable programs that are configured to control the aggregator 100 and/or elements of the aggregator 100, and may include programs to control accessory devices 150 that may be connected to the aggregator 100. The processor 110 is configured to handle and manage incoming data from a number of accessory devices and also control access to the aggregator 100 by a user. Further, the processor 110 is configured to control data read-write to and from the storage 112 and can employ use of storage 114 to accomplish the read-write function. Alternatively, the one or more executable programs may be stored in the storage device 112. The processor 110, through the executable programs, controls, stores, deletes, transfers, and/or manipulates the data and information of the aggregator, the accessory devices, and user information. Further, the processor 110 is programmed, or contains or uses a program, to process incoming data from different formats and/or different transmission formats, such as Bluetooth and wireless network protocol (e.g., Wi-Fi). Accessory devices may connect to the aggregator 100 using a Generic Attribute Profile (“GATT”) to define how the accessory devices transfer data or messages to the aggregator 100. A conversion protocol, within the aggregator 100, may then be used to convert the data to be transferred onto the internet for access by an access device 170 or for access by direct connection between the access device 170 and the aggregator 100. Moreover, the processor 110 may contain, and/or be connected to, an authentication chip 130 or program used to authenticate the aggregator 100. Authentication may be used, for example, to authenticate the aggregator 100 for compliance with a licensing program or standard, such as “Made for iOS” accepted by Apple.

The processor 110 also may be configured to allow control over accessory devices 150 connected to the aggregator 100, with a data connection. For example, the processor 110 may send commands, by wireless or wired connection, to one or more connected accessory devices, thereby controlling the accessory devices. For example, sending on/off commands, controlling volume, controlling power levels, such as for a dimmable light bulb, or for any other function the accessory device 150 is configured to carry out or operate.

Data storage on the aggregator 100 is achieved through one or more storage devices, such as the non-volatile storage device 112. The storage device 112 is configured to store data collected from a number of accessory devices, identification information related to each of the accessory devices, and operational programs, for example. When data is received at the aggregator 100, the processor 110 processes the incoming data and uses the storage device 114 to write the data to the storage device 112. The information and data can then be stored in the storage device 112 for a duration of time, such as until a user accesses the information, or until a user decides to erase the data. Alternatively, the aggregator 100, and processor 110, can be configured to erase data after a pre-designated amount of time. In such an embodiment, the processor 110 is configured to control the storage device 112 to delete information or data that has been stored for longer than the pre-designated amount of time. Although described herein as using a volatile storage 114, those skilled in the art will appreciate that other methods of writing data and storing data may be used. Alternatively, the aggregator may be configured without onboard storage and memory, and may employ cloud-based, internet based, and/or remote storage.

The storage device 112 may also store user data, documents, files, user commands, and/or data collected from the internet. The storage device 112 is a non-volatile storage device for storing electronic data. The storage device 114 is a volatile storage device that is used by the processor 110 to quickly access information for programs or other processes. Accordingly, those of ordinary skill in the art will appreciate that the processor 110 and storage devices 112 and 114 can be configured and arranged as known, or will become known, in the art.

The information and data received by the aggregator 100 is received through antennae 117, 119, and 141 at radios 116, 118, and 140, and/or through an Ethernet, e.g. a wired, connection. The radios 116, 118, and 140 are transmitter-receiver devices capable of supporting multiple modes of wireless communication. As shown, radio 116 is a Bluetooth radio, radio 118 is a BLE radio, and radio 140 is a Wi-Fi radio. Accordingly, a plurality of wireless devices can connect to the aggregator 100 via one or more modes of communication. Although shown with radios configured for Bluetooth and Wi-Fi communication, those of ordinary skill in the art will appreciate that other types of wireless connection and communication may be made between the aggregator 100 and accessory devices, and as such the aggregator 100 is not limited merely to a Bluetooth/Wi-Fi-configuration. For example, the aggregator may include other wireless network protocols (e.g., ZigBee®, etc.) or other wireless-type radios.

Additionally, the aggregator 100 may include one or more ports for wired connections with accessory devices and/or access devices. For example, an accessory device may be in communication with the aggregator 100 through a wire, such as an Ethernet cable, a USB cable, or any other communication cable that is known or may become known. In such configuration, the microprocessor 100 and/or an Ethernet controller 120 is configured to handle and/or manage data that is received over a wired connection.

The aggregator 100 may also include an ON/OFF switch (not shown) and an LED or other display (not shown) to indicate the status of wired and wireless connections, whether the unit is ON or OFF, and similar information. The display can show activity or may be a display configured to display information that is received, stored and/or collected on the aggregator 100 to a user, and controlled by the processor 110. For example, the display may be configured to display the information or data of one or more currently connected accessory devices. The aggregator 100 can be further configured to allow cycling through all of the connected accessory devices and display the current information for each device, either individually, in groups, or collectively, and allow control thereof, such as to connect or disconnect an accessory device, and/or send commands to the accessory devices to control such devices from a single location at the aggregator 100.

As noted, the aggregator 100 includes an Ethernet controller 120 and a Wi-Fi radio 140. The Ethernet controller 120 and/or Wi-Fi radio 140, and the processor 110, allow for the aggregator 100 to be IP addressable. This allows for access to the aggregator 100 from any authorized device via the Internet 160. Moreover, the internet connection can allow the aggregator 100 to communicate with external elements, such as servers, webpages, etc. In the illustrated embodiment, the Ethernet controller 120 is connected to a router, modem, or other device through an Ethernet port 121, such as an RJ-45 port. Although shown and described as a hardwired Ethernet connection, those skilled in the art will appreciate that the aggregator 100 can connect to the internet via wireless communication, such as wireless network protocol (e.g., Wi-Fi) or cellular network, or other type of wired connection, such as a USB connection. Accordingly, the aggregator is not limited to a wired connection, but other internet connection methods and means known or will become known may be used to connect the aggregator to the internet.

The internet connection allows for a user to remotely access the aggregator 100 and any data stored thereon and in certain embodiments allow a user to remotely control the aggregator 100 and/or any accessory devices 150 connected thereto. For example, a user may use a computerized application, such as an application on a smart phone or other device, to access a server through the internet. The server acts as a portal to the aggregator 100 by using the aggregator's IP address. The user can then access and/or download information from the aggregator 100 to the smart phone, or other device, to be able to monitor the information collected from the accessory devices that are in continuous communication with the aggregator 100, or to control the aggregator 100 and/or the accessory devices 150 connected thereto. Alternatively, a user may in some embodiments use an access device to directly connect to the aggregator through a direct connection using the aggregator's IP address, if it has one.

Referring again to FIG. 2, a system configuration using the aggregator of FIG. 1 is shown. As shown, the aggregator 100 is in wireless or wired communication with a plurality of accessory devices 150 (generically 150, and specifically 151, 152, 153, and 154). The aggregator 100 is in communication with the internet 160 by wired or wireless means known in the art, as discussed above. The connections between the accessory devices 150 and the aggregator 100 are as described above. The accessory devices 150 are Bluetooth or wireless network protocol (e.g., Wi-Fi) enabled devices or wired devices that communicate with the aggregator 100.

The accessory devices 150, for example can include health monitoring devices 151, home security devices 152, home appliances 153, and home electronics 154. Although described herein as home devices, those skilled in the art will appreciate that the accessory devices 150 can include any Bluetooth or other wireless or wired device, whether related to the home, office, retail, commercial, or other application, that is configured to monitor conditions and/or collect data from the device or environment. Alternatively, in some embodiments, each accessory device could be a Bluetooth connected tag or other device attached to various items of inventory or products in a retail setting. Further, the aggregator can be used with any number of devices, more or fewer than (even one) shown in FIG. 2.

Moreover, although shown in the embodiment of FIG. 2 with a single aggregator 100, multiple aggregators may be connected to each other with data connections to form a large system that allows for a larger area of coverage, with each aggregator providing a discrete coverage area, and/or to allow for more accessory devices 150 to be connected to the system. Each aggregator 100 may then serve as an access point for users and for the accessory devices. In some embodiments, if an accessory device or access device moves from the coverage area of a first aggregator into the coverage area of a second aggregator, the connection can seamlessly transfer between the two aggregators, such as by soft or hard handoffs that are known in the art, thereby maintaining a communication and/or data connection between the accessory device or access device and the aggregator system. Further, any number of aggregators may be configured in this fashion.

Each of the accessory devices 150 can communicate with the aggregator 100 through the antennae 117, 119, and 141 and radios 116, 118, and 140 and/or through other wireless or wired means. When an accessory device 150 comes into communication range with the aggregator 100 for the first time, the accessory device 150 can establish communication with the aggregator 100, or the aggregator 100 can recognize that a new accessory device is in range and establish a communication link between the aggregator and the accessory device 150. When a communication and/or data connection is established between an accessory device 150 and the aggregator 100, the aggregator 100 can set up or configure the storage device 112 to store information collected from the specific accessory device, such as in a file system, folder system, or other form of data storage. The information collected from the accessory device may include a unique identification number, product type identification, or other similar information, which may be used for controlling the accessory device and/or tracking the specific accessory device, or for other purposes that are known or will become known, such as for directing commands from the aggregator 100 to a specific accessory device. Each accessory device 150 may have a unique identification number associated therewith and the aggregator 100 can receive and store data associated with each accessory device 150 separately, based on the unique identification. The identification information allows the aggregator 100 to collect data from the accessory device and store the information and collected data such that it can be easily retrieved. However, some accessory devices may not have unique identification numbers, and may be identified by type, manufacturer, or other identification information. Accordingly, the aggregator 100 can assign an identification number to an accessory device when the accessory device first connects to the aggregator 100.

Alternatively, the aggregator 100 may be configured to obtain information about the accessory device 150 through the internet when the accessory device 150 is initially connected. In some embodiments, the aggregator can maintain a device list without requiring an accessory device to be connected to the aggregator. The aggregator 100 can use the internet connection made through the Ethernet controller 120 or Wi-Fi radio 140 to download the information. This can include compatible device lists from various manufacturers' websites or from a central storage location, such as a server. This allows for the aggregator 100 to continuously update the aggregator system to enable compatibility with new devices. For example, a manufacturer may want a device to be able to communicate with the aggregator. The internet connection allows the aggregator to connect to a central information page, such as an FTP site, to download the information related to the new device to be connected to the aggregator. The aggregator can then store the product information into the memory such that when a new device that is listed in the product information comes into range with the aggregator, the connection between the new device and the aggregator may be achieved without additional action on the part of a user. Alternatively, information regarding new devices may be sent to the aggregator directly from a manufacturer, vendor, or other provider, in embodiments where the aggregator 100 is IP addressable, or the manufacturer, vendor, or other provider can upload the information to the central information page for downloading.

Unique identification information, whether pre-assigned or assigned by the aggregator, also allows the aggregator 100 to request specific information from a specific accessory device 150 and/or send commands to a specific accessory device. Accordingly, using unique identification information allows for the aggregator 100 to address one or more specific accessory devices 150, even if the aggregator is actively connected to multiple accessory devices 150.

The aggregator 100 may control accessory devices and/or send commands thereto. For example, the aggregator 100 can provide over-the-air programming of the accessory devices 150, including sending firmware upgrades, or setting control parameters for the accessory device. If an accessory device includes non-volatile memory that is writable, as compared to read-only, the aggregator 100 can provide updates and/or programming to the accessory device 150 through the communication and/or data connection between the aggregator 100 and the accessory device 150. This can include, for example, software or operating system updates from the manufacture, which are downloaded to the aggregator, either pushed to or pulled by the aggregator, via its internet connection. Similarly, the aggregator 100 may allow for, and/or automatically conduct, reconfiguration of an accessory device 150, for example to change the monitoring settings of the accessory device, or merely control the accessory device to turn on or turn off, or perform some other function the accessory device is capable of carrying out.

As shown in FIG. 2, the communication channel between the aggregator 100 and the accessory devices 150 may be two-way. The accessory devices 150, once a connection is established with the aggregator 100, can send information and/or data from the accessory device 150 to the aggregator 100 e.g., either at pre-set intervals or continuously in real-time. The aggregator 100 can then store the incoming data in the on-board storage 112. Because the aggregator 100 is often stationary and provided with power, the aggregator can maintain continuous communication with the accessory devices 150, even if they are moved. This enables the accessory devices 150 to send data or information to a receiving device (the aggregator 100) whenever data is collected, in real-time, and eliminates the need for the devices to have on-board storage. Additionally, this allows a user to track the data collected by the accessory device, even if the user is not within range of the accessory device to monitor it.

In some embodiments, there is a reverse communication channel from the aggregator 100 to the accessory device 150. The aggregator 100 can then send information and/or commands to the accessory devices, thereby allowing a user to control multiple accessory devices from a single location and/or interface, e.g., a user can control one or more accessory devices with a single communication and/or data connection to the aggregator 100, rather than having to connect to each accessory device 150 individually.

A user can interact with the aggregator 100 using an access device 170. When a user comes into range of the aggregator 100 with an access device 170, such as a smart phone, the access device 170 can establish a wireless connection with the aggregator 100. The wireless connection between the access device 170 and the aggregator 100 may use one or more of the antennae 117, 119, and 141 and radios 116, 118, and 140. For example, the access device 170 may wirelessly connect to the aggregator 100 using a Wi-Fi connection directly to the aggregator 100. Alternatively, the access device 170 may use a Bluetooth connection to connect to the aggregator 100, for example using one of the radios 117 or 119. Alternatively still, the access device 170 can access the aggregator 100 through the internet connection of the aggregator 100. For example, a user may operate a computerized application on a smart phone that accesses a portal that directs the user to the aggregator 100, thereby accessing the information and data stored on the aggregator 100. Alternatively still, the access device 170 may connect to the aggregator 100 by other wireless means or by means of a wire or other physical connection. Further, when a user is in range of the aggregator 100 or otherwise in contact with the aggregator 100 (e.g., via the internet or cellular connection), the user may employ the aggregator 100 to actively ping or communicate with one or more accessory devices to pull real-time and/or stored information from the one or more accessory devices and/or to send commands from the user to the accessory device. Accordingly, in applicable embodiments, a user can make an active query or command, through the aggregator, of the accessory devices that are in communication with the aggregator 100. This active query or command can be initiated automatically by a user coming into range of the aggregator or may be done through an active process initiated by a user command.

When a user accesses the aggregator 100 with an access device 170, the user may control the aggregator 100, the data stored therein, and/or the accessory devices 150 connected to the aggregator 100. For example, a user may access and view data and information associated with the various accessory devices 150 that are connected to the aggregator 100. A user may also control the data stored on the aggregator, such that the user may delete information, instruct the aggregator to stop communicating with specific accessory devices, or provide other commands to the aggregator. A user may also remotely access one or more accessory devices through the aggregator to thereby control such accessory devices.

In one exemplary embodiment, a user may employ a computerized application (such as an “app” on a mobile device, or a program on a computer) on an access device, e.g., a mobile device or computer, that organizes the data by accessory device that is connected to the aggregator. The application may be an “app” for iOS, Android, Blackberry/RIM or other operating systems. The application can provide a user connection with the aggregator or a remote server that is in communication with the aggregator. The application may be configured with a user interface that allows a user to use the access device to control the aggregator, to control the accessory devices connected to the aggregator, and/or to access information collected by the aggregator.

The application or app may permit remote access and/or collects the data from the aggregator and/or remote internet storage, and makes it available for viewing by the user in the application. Accordingly, a user may view the information related to one or more of a plurality of accessory devices connected to the aggregator through the application. The user may further use the application to switch between viewed accessory devices, and therefore the user can access all of the devices that are connected, wired or wirelessly, to the aggregator, or subsets of the accessory devices connected to the aggregator, for example, by type, location, purpose/use, or other criteria. Moreover, the aggregator may allow for active control of the accessory devices connected therewith. For example, a user may provide instructions to an accessory device through the aggregator, such as instructing a connected coffee maker to start brewing coffee, start a connected shower to start running the hot water, start or warm up a connected car, etc.

For example, by using the application, a user can open a screen that shows a list of all devices connected to the aggregator, or in some embodiments the devices connected to multiple aggregators configured in a system. The user can then select one or more of the devices from the list and the application can display information for a particular accessory device. For example, the application can display status information for the accessory device and also display information that has been collected by the aggregator. Moreover, the application can provide optional commands for the accessory device, such as “turn on,” “turn off,” “start,” “dim,” or any other type of operation that the particular accessory device is capable of doing. The application may be configured to display the information in various formats, such as display text, graphical depictions, or any other display format. For example, for a thermostat, the application on the access device can display the temperature, and control options for adjusting the temperature. As another example, the application can display a layout of a home, with a control for each room, and the lights could be turned on, turned off, dimmed, etc. through controls in the application and then commands sent from the access device to the aggregator, and relayed to the specific accessory device to be controlled.

The display features on the access device for each connected accessory device may be the same, within an application specific to the aggregator. Alternatively, the application may serve as a common application that has sub-applications within or accessed by it, specific to each accessory device. These sub-applications can be designed and/or maintained by the manufacturer of the accessory device. Accordingly, the application provides a single application or application family with access to each device and/or device application, such that only a single interface is required to display the information from the plurality of accessory devices connected to the aggregator.

In other embodiments, the aggregator 100 serves as a control device for the one or more accessory devices 150 connected thereto. The aggregator uses onboard memory storage 112, 114, and/or remote storage (e.g., an external hard drive or cloud storage on the internet), and processor 110, and programs stored thereon or employed thereby, to recognize or “learn” user habits over time, establishing a set of predefined inputs and predefined outputs. Those of ordinary skill in the art will appreciate that various computer programs and/or programming known or that become known can be used to program the aggregator 100 to “learn” and automatically execute actions, such as rule engines, inference engines and knowledge base, expert systems, and/or other types of computer programming.

The aggregator 100 can store historical data of user actions and/or inputs that are input to the aggregator 100 and/or accessory devices 150, and may also recognize actions/inputs as being related to each other, e.g., based on relative times and/or order of the actions/inputs. Over time, the aggregator 100, and processor 110 thereof, can recognize patterns to establish or build a rule engine, discussed in more detail below. For example, if a light is connected to the aggregator 100, it can transmit to the aggregator 100 when it is turned on or turned off. Alternatively, if a user turns on or turns off that connected light using the aggregator 100, e.g., through the application on the access device, the aggregator 100 will store that action, including, for example, the time at which the action took place. If a user, over time, turns on that light at a certain time every morning (or within a range of time for which the aggregator 100 is programmed to recognize the actions as being associated with each other, e.g., within a ten-minute window), the aggregator 100 can recognize or “learn” this and automate this action, and instruct the light to turn on at the specific time, without instruction from the user. The memory storage 112, 114, or alternatives thereof, of the aggregator 100, allows for this historical recording and “learning.” If the user subsequently begins turning on the light at a different time or time range, the aggregator 100 can recognize the change in behavior, and adjust the time at which it instructs the light. Yet further, the aggregator 100 may distinguish between different days of the week, recognizing and establishing different patterns for different days, e.g., a weekday as compared to a weekend.

Alternatively, in some embodiments, a user can program the aggregator 100 with specific inputs and outputs. For example, a user can program the aggregator 100 to turn off all lights in the house and ensure the oven is off, every time the front door is locked. This eliminates the need for the user to either go to each light switch, or turn off each light through the access device. Those skilled in the art will appreciate that in the above example, each of the devices is an accessory device 150 that is connected to the aggregator 100 for this automated process to occur.

The aggregator 100, after “learning” or being programmed by a user, can thus provide a fully automated process for a user, recognizing when certain events occur and provide the “learned” and/or programmed response when such event is registered by the aggregator 100. Due to the two-way communication between the aggregator 100 and the accessory devices 150, the aggregator 100 can recognize when an event occurs, such as locking or unlocking a door, turning a light on or off, etc. In such events, the aggregator 100 can employ a rule engine for performing additional actions and/or tasks. The rule engine may be a simple if/then program, wherein “if” an event “A” occurs, “then” the aggregator 100 performs a list of “learned” and/or programmed operations to control any and/or all connected accessory devices 150. For example, if a bedroom light is turned on in the morning, the aggregator 100 then will turn on bathroom lights to a specific brightness (or dimness), activate a coffee maker to start brewing fresh coffee, initiate a remote starter for a car to warm or cool the car, and turn on the shower and provide a user defined or preferred water temperature. The list of actions to be performed can be learned by the aggregator 100 in view of programmed criteria to recognize that the above actions are associated with each other. For example, the aggregator 100 can be programmed to associate the actions, and thus perform the actions automatically, if a user performs the above actions on a regular basis, e.g., all or on a threshold number of weekdays, within a threshold time period, e.g., an hour.

As another example, when a user locks their house, the aggregator 100 can then execute the rule engine, and make sure all lights are turned off, or that only certain lights are on, and/or can control any running appliances to ensure that they are running according to a user's preferences, such as turning off the oven or washing machine if it is running when the user leaves the house, or controlling the temperature of the thermostats of the house to maintain efficiency. As will be appreciated by those of skill in the art, all of the devices disclosed herein that are connected to the aggregator are merely examples of accessory devices, and any device that is connectible to the aggregator can be controlled in such a fashion.

As noted above, the rule engine of the aggregator 100 can be pre-programmed by a user and/or generated by the aggregator programming through user habits and operation, or combinations thereof. Advantageously, the aggregator may reduce or eliminate the need for direct user interaction and control over any and/or all accessory devices connected to the aggregator, and may even provide a fully automated system. Moreover, as discussed above, the aggregator system can reduce the number of connections and/or controls a user needs to make in order to perform activities related to the connected accessory devices.

In addition to providing connection with the accessory devices 150 and access devices 170, the aggregator 100 may also provide a wired or wireless access point to the internet for any devices in range. The antenna 141 can be configured with a wireless network protocol (e.g., Wi-Fi) radio and broadcast a wireless network protocol (e.g., Wi-Fi) connection, to serve as a wireless hotspot. Further, the aggregator 100 may include USB, Ethernet ports, or other similar hardwired ports for connection of devices to the internet. Accordingly, the aggregator can be configured as a router or modem for general internet connectivity.

Further, although embodiments herein describe the aggregator as a stand-alone or separate unit or device, the aggregator disclosed herein can be incorporated within other devices. For example, the aggregator and functionality thereof, can be incorporated into other systems and devices such as thermostats, routers, computers, home security systems, smart home controllers, TV's, etc. Alternatively, the disclosed functionality of aggregation, information collection, and control can all be implemented in one of these other devices, rather than as a separate hardware component installed therein. For example, a smart home controller can be configured as an aggregator disclosed herein.

As may be recognized by those of ordinary skill in the pertinent art based on the teachings herein, numerous changes and modifications may be made to the above-described and other embodiments of the present invention without departing from its scope as defined in the appended claims. Accordingly, it is to be understood that this detailed description is to be taken as illustrative and not to be limited to the specific embodiments disclosed and that modifications and other embodiments are intended to be included within the scope of the appended claims. It should be understood that although certain features are described in the embodiments in combination with certain other features, that the invention is not limited to such combinations, and the invention contemplates and covers the features described herein in any and all possible combinations. Further, although specific terms are employed herein, they are used in a generic and descriptive sense only and not for purposes of limitation. In addition, though the invention may be used for personal data collection from a number of wireless accessory devices, it should be understood that the invention may be utilized for other applications as well. Accordingly, this detailed description of embodiments is to be taken in an illustrative as opposed to a limiting sense.

What is claimed:

1. An aggregator comprising:
at least one wireless radio configured to communicate with one or more accessory devices to at least one of collect data therefrom and send data thereto;
a processor in communication with the at least one wireless radio and configured to receive and process data collected from the one or more accessory devices and configured to process and send data from the aggregator to the one or more accessory devices, the processor further configured to receive inputs from a user to control the aggregator and/or the one or more accessory devices;
a first memory in communication with the processor and configured to store the collected data; and
a second memory in communication with the processor and configured provide read-write capabilities to the aggregator.

2. An aggregator as defined in claim 1, further comprising an internet controller configured to connect the aggregator to the internet.

3. An aggregator as defined in claim 2, wherein the aggregator is configured to allow a user to access the aggregator through the internet.

4. An aggregator as defined in claim 1, wherein the at least one wireless radio comprises a Bluetooth wireless radio.

5. An aggregator as defined in claim 1, wherein the at least one wireless radio comprises a Bluetooth Low Energy wireless radio.

6. An aggregator as defined in claim 1, wherein the at least one wireless radio comprises a wireless network protocol radio.

7. An aggregator as defined in claim 1, wherein the first memory comprises non-volatile memory and the second memory comprises volatile memory.

8. An aggregator as defined in claim 1, further comprising at least one communications port configured to allow wired communication between at least one of the one or more accessory devices and the aggregator.

9. An aggregator as defined in claim 1, wherein the processor is configured to be controlled by a program on a user device.

10. A method comprising:
establishing a data communication connection between an aggregator and one or more accessory devices;
receiving at the aggregator information transmitted from at least one of the one or more accessory devices;
storing the received information on the aggregator; and
transmitting the received information from the aggregator to a user.

11. A method as defined in claim 10, wherein the one or more accessory devices comprise Bluetooth enabled devices, and the data communication connection comprises a wireless Bluetooth connection.

12. A method as defined in claim 10, wherein the storage of the received information is first stored in a volatile memory for a duration and then transferred to a non-volatile memory for longer storage times.

13. A method as defined in claim 10, further comprising transmitting from the aggregator at least one of a command and information to at least one of the one or more accessory devices to control the accessory device.

14. A method as defined in claim 13, wherein the transmitting of a command or information is initiated by a user.

15. A method as defined in claim 14, further comprising providing the command or information from at least one of a manual input, a wireless connection from an access device, and from the internet.

16. A method as defined in claim 10, further comprising transmitting the received information from the aggregator to a server for at least one of storage, processing, and remote access by a user.

17. A method as defined in claim 10, wherein the step of transmitting the received information is initiated by a request of a user.

18. An aggregator system comprising:
an aggregator configured to communicate with one or more accessory devices by a data connection thereto, and configured to at least one of store information collected from the accessory devices, receive information from the one or more accessory device, and send at least one of commands and information to the one or more accessory devices by the data connection; and
an access device configured to communicate, using a computerized application, with the aggregator to, by the data connection, at least one of obtain the stored information, send at least one of commands and information to the one or more accessory devices, and retrieve information from the one or more accessory devices.

19. An aggregator system as defined in claim 18, wherein the communication between the aggregator and the one or more accessory devices comprises wireless communication.

20. An aggregator system as defined in claim 19, wherein the wireless communication comprises at least one of Bluetooth, low energy Bluetooth, and wireless network protocol.

21. An aggregator system as defined in claim 18, wherein the access device comprises a wireless computing device.

22. An aggregator system as defined in claim 21, wherein the application comprises a user interface configured to display at least one of information comprising the stored information, at least one of commands and information to be sent to the accessory devices, and commands to control the aggregator.

23. An aggregator system as defined in claim 18, wherein the access device is further configured to control the aggregator.

24. An aggregator system as defined in claim 18, further comprising at least one additional aggregator in a communication connection with the aggregator and configured to communicate with one or more additional accessory devices by a data connection thereto, and configured to, by the data connection, at least one of store information collected from the one or more additional accessory devices, receive information from the one or more additional accessory devices, and send at least one of commands and information to the one or more additional accessory devices.

25. An aggregator system as defined in claim 24, defining, through the communication connection between the aggregator and the at least one additional aggregator, the data connection between the aggregator and the one or more accessory devices, and the data connection between the at least one additional aggregator and the one or more additional accessory devices, a communication system configured to allow communication among any of said aggregators, the one or more accessory devices, and the one or more additional accessory devices.

26. An aggregator system as defined in claim 24, wherein the communication system, through a communication connection between the access device and the aggregator, is configured to allow communication among the access device and any of said aggregators, the one or more accessory devices, and the one or more additional accessory devices.

27. An aggregator system as defined in claim 24, wherein the at least one additional aggregator is configured to, when information is received by the at least one additional aggregator from one or more of the one or more additional accessory devices, send at least one of commands or information to one or more of the one or more accessory devices in response to the received information through said communication connection with the aggregator and communication between the aggregator and the one or more of the one or more accessory devices.

28. An aggregator system as defined in claim 24, wherein when the access device is connected to the aggregator or the at least one additional aggregator, the access device is configured to at least one of obtain information stored on any of said aggregators, send at least one of commands and information to accessory devices in communication with said aggregators, and retrieve information from accessory devices in communication with said aggregators.

29. An aggregator system as defined in claim 24, wherein the aggregator and the at least one additional aggregator each define an area of coverage within which an accessory device is connectable thereto.

30. An aggregator system as defined in claim 29, wherein the areas of coverage at least partially overlap so that said accessory device remains connected to at least one of the aggregator and the at least one additional aggregator as it moves between the coverage areas of the aggregator and the at least one additional aggregator.

31. An aggregator system as defined in claim 18, wherein the access device is configured to communicate with the one or more accessory devices and configured to at least one of obtain information directly from the one or more accessory devices and send at least one of commands and information directly to the one or more accessory devices by a data connection between the access device and the one or more accessory devices.

32. A system comprising:
a first unit comprising a processing unit and at least one storage device, the processing unit configured and adapted to control the first unit to at least one of communicate with one or more accessory devices, and at least one collect information therefrom and send at least one of commands and information thereto, the at least one storage device configured and adapted to at least one of store information collected from the one or more accessory devices, store programs configured to control the one or more accessory devices, and store information about each of the one or more accessory devices; and
a second unit comprising a computerized electronic device having hardware and at least one of firmware and software adapted and configured for installation of a computer application adapted and configured such that the second unit is adapted and configured to communicate with the first unit, wherein the second unit is further adapted and configured to permit a user to at least one of (i) send at least one of information and commands from the first unit to the one or more accessory devices and (ii) collect information from the first unit.

33. A system as defined in claim 32, wherein the first unit comprises an aggregator.

34. A system as defined in claim 32, wherein the second unit comprises a wireless computing device.

35. A system as defined in claim 32, wherein the first unit is wirelessly connectable to at least one of the one or more accessory devices.

36. A system as defined in claim 35, wherein the wireless connection is at least one of Bluetooth, Bluetooth low energy, radio frequency, and wireless network protocol.

37. A system as defined in claim 32, wherein the computer application is a mobile application program.

38. A system as defined in claim 32, further comprising an internet server configured to facilitate communication between the second unit and the first unit.

39. A system as defined in claim 32, wherein the computer application comprises a user interface presented on the second unit and configured to allow viewing of at least one of (i) the information collected by and stored on the first unit and (ii) commands or information capable of being sent to at least one of the first unit and the one or more accessory devices.

40. A system as defined in claim 39, wherein the computer application user interface is configured to allow for a user to control the first unit.
